(19) United States
(12) Patent Application Publication
(10) Pub. No.: US 2015/0016487 A1
(43) Pub. Date: Jan. 15, 2015

(54) Flexible Temperature and Strain Sensors

(71) Applicant: PST Sensors (Proprietary) Limited, Cape Town (ZA)

(72) Inventors: David Thomas Britton, Cape Town (ZA); Margit Harting, Cape Town (ZA)

(73) Assignee: PST Sensors (Proprietary) Limited, Cape Town (ZA)

(21) Appl. No.: 14/375,464

(22) PCT Filed: Jan. 30, 2013
(86) PCT No.: PCT/IB2013/050778

§ 371 Date: Jul. 30, 2014

(30) Foreign Application Priority Data
Jan. 30, 2012 (ZA) 2012/00709

(51) Int. Cl. G01K 1/26; G01K 7/24; G01L 1/22

(52) U.S. Cl. CPC G01K 1/26; G01L 1/22; G01K 7/24
USPC 374/185

(57) ABSTRACT

A strain compensated temperature sensor includes a first, temperature dependent resistor, and a second, substantially temperature independent resistor connected in series with the temperature dependent resistor. At least one electrical contact allows an electrical potential difference to be applied across both resistors simultaneously. Both the temperature dependent resistor and the substantially temperature independent resistor are sensitive to mechanical strain. This permits temperature readings from the sensor to be corrected automatically for mechanical distortion of the sensor. The temperature dependent resistor and the substantially temperature independent resistor are of substantially similar construction, preferably being located adjacent one another in or on a common substrate, and hence have a similar response to a mechanical force applied to them.

### BACKGROUND OF THE INVENTION

THIS invention relates to sensor devices such as temperature sensing devices, and to a method of producing such devices.

In many applications, in fields as diverse as engineering, health care, packaging and transport it is desirable to obtain quantitative information on the temperature of a large irregularly shaped object, or of a complex structure whose shape or configuration may change under different conditions or be caused to change. Such an object may be made, for example, of thin flexible material such as fabric, polymer film or paper which is subject to external or internal forces. An example of the latter could be a sealed container containing a fluid, the pressure of which is varied causing the container to deform. Alternatively, the object may be an articulated engineering component or a flexible membrane subject to flexing or tension.

A common method used for such measurements is infrared or visible thermography, in which the thermal radiation emitted by the object is recorded by a digital camera. While having the advantage, for some applications, of being a non-contact measurement, this is often a disadvantage due to factors such as extraneous radiation, poor visibility and obscuring of the field of view, transparency of the material and variation in emissivity and reflectivity. It is therefore often desirable to utilize a sensor which is in good direct thermal contact with the object.

Presently, when a direct temperature measurement is required, individual discrete components are mounted onto or held in contact with the object.

The sensors used are either thermocouples or, more often, resistive devices such as thermistors.

It is an object of the invention to provide an alternative temperature sensing device which is able to compensate for deformation or localised movement of an object to be measured.

### SUMMARY OF THE INVENTION

According to a first aspect of the invention there is provided a sensing device including a first, temperature dependent resistor, a second, substantially temperature independent resistor connected in series with the temperature dependent resistor, and at least one electrical contact by means of which an electrical potential difference can be applied across both resistors simultaneously, wherein both the temperature dependent resistor and the substantially temperature independent resistor are sensitive to mechanical strain.

Preferably the temperature dependent resistor and the substantially temperature independent resistor are of substantially similar construction and hence have a similar response to a mechanical force being applied to them.

The temperature dependent resistor and the substantially temperature independent resistor are preferably supported by or mounted on a common substrate, which may be flexible or elastic.

Preferably both the temperature dependent resistor and the substantially temperature independent resistor are located adjacent one another in or on the substrate.

A measurement of the potential difference across the fixed resistor is then used to determine the mechanical distortion of the sensor, and the measurement of the relative potential differences across the temperature dependent resistor, which indicates the change in temperature, is automatically corrected for mechanical distortion of the sensor.

The sensing device may include a third, load resistor, the resistance of which is substantially unaffected by either the mechanical strain or the change in temperature experienced by the first and second resistors.

This can be achieved by either including a load resistor in the form of a rigid temperature independent resistor (that is, a resistor that is temperature and strain insensitive) in or on the substrate of the sensing device, or by mounting a fixed resistor of any construction at a point in the monitoring circuit which is not subject to these influences, for example at the input of the measuring or recording instrument.

A strain compensated temperature sensor according to the present invention may include first and second strain sensitive resistive sensor elements, one temperature dependent and one temperature insensitive.

In one example embodiment, the first and second strain sensitive resistive sensor elements may by formed by providing first, second and third conductive tracks, providing a first track of resistive material extending between the first and second tracks, and providing a second track of resistive material extending between the second and third tracks.

The sensor elements may have a spiral or meander pattern.

In another example embodiment, the first and second strain sensitive resistive sensor elements comprise interdigitated first and second conductive tracks, with a meandering third conductive track disposed between the interdigitated first and second conductive tracks, with at least one first track of resistive material extending between the first conductive track and the third conductive track, and at least one second track of resistive material extending between the second conductive track and the third conductive track.

In such an embodiment, a plurality of first and second tracks of resistive material may be arranged alternately so that each first track of resistive material extends between a finger of the first conductive track and the third conductive track, and each second track of resistive material extends between a finger of the second conductive track and the third conductive track.

Such a sensor has a preferred axis with enhanced strain sensitivity.

### BRIEF DESCRIPTION OF THE DRAWINGS

FIG. 1 is a schematic diagram illustrating the principle of the sensing circuit of a temperature and strain sensing device according to the invention;

FIG. 2 is a schematic plan view of a first embodiment of a temperature and strain sensor of the invention;

FIG. 3 is a schematic plan view of a second embodiment of a temperature and strain sensor of the invention; and

FIGS. 4a and 4b are schematic plan views of a third embodiment of a temperature and strain sensor of the invention.

### DESCRIPTION OF EMBODIMENTS

The present invention relates to temperature and/or strain sensing devices and methods of producing such devices. In particular, the devices may be large area temperature dependent resistors, fabricated on flexible substrates. Of particular relevance here are thermistors which have a negative temperature coefficient of resistance, commonly known as NTC thermistors, meaning that their electrical resistance decreases approximately exponentially with increasing temperature.

The present invention therefore concerns the use of thermistors, specifically printed negative temperature coefficient (NTC) thermistors, which can be applied as single large area sensor to determine an average temperature or as a temperature sensing array as described in (sensor array), where the sensors may be individually addressed or addressed as a row and column matrix. The present invention is not restricted to printed NTC thermistors, but is equally applicable to any flexible temperature sensor, the resistance of which changes with temperature, and so may equally applied to a positive temperature coefficient (PTC) thermistor or resistance temperature device (RTD), and to any such device fabricated on a flexible substrate material.

Printed and thin film temperature sensors, such as those described above, suffer from a common disadvantage in that factors other than temperature may also influence their resistance. One such factor is an applied mechanical force, which may be either in the form of bending or lateral stretching of the sensor, or a change in the pressure applied to its surface.

Two mechanisms for the change in electrical resistance have been identified, for the type of sensors under consideration. Firstly, for a lateral stretching, bending or torsion (twisting) of the flexible substrate, there is a change in separation of the electrical contacts deposited on it. With respect to the strain, the relative magnitude of this effect depends principally on the geometry of the resistor and not on the material which it comprises. On the other hand, the magnitude of the resistance change with respect to the applied tension depends primarily on the stiffness of the substrate.

The second cause of a change in resistance, under an applied pressure, is compaction of the active material of the sensor in a direction perpendicular to the substrate. For a homogeneous material the main factor governing the change is its compressibility, leading to a decrease in its effective thickness for a positive pressure and hence an increase in resistance. However, for an inhomogeneous material, such as a printed layer composed of a network of particles, there is also a reversible reconfiguration of the network structure which can increase the number of conducting paths, and hence cause a decrease in resistivity for an increase in pressure.

For the purposes of the present invention, all changes in the relative size or shape of the devices under consideration will be referred to as strain, irrespective of whether this change corresponds to an extension, contraction, compression, expansion, shear, bending, torsion, or combination thereof.

A generalised basic circuit according to the present invention comprises a temperature dependent resistor in series with a temperature independent resistor, which is of similar construction and hence has a similar response to strain caused by mechanical force applied to a region of a sensing device including both resistors. By measuring variations in the potential difference across the temperature independent resistor, the mechanical distortion of the sensor can be determined. This information can be used to correct a measurement of the potential difference across the temperature dependent resistor, which indicates the change in temperature. Thus, in the case of a temperature sensor, the temperature reading of the sensor is automatically corrected for mechanical distortion (strain) of the sensor.

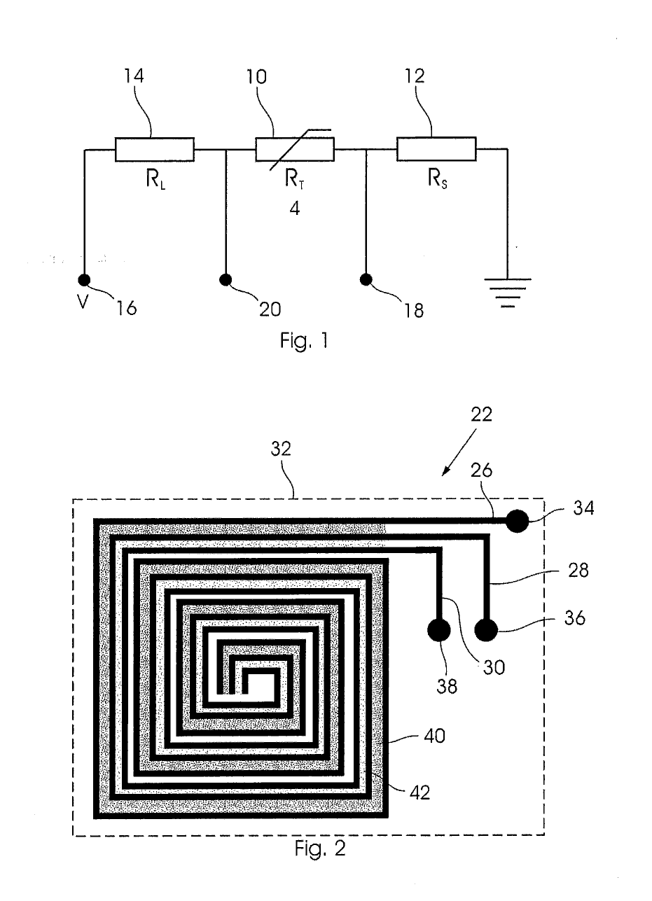

The effective circuit for this arrangement is shown in FIG. 1. A temperature dependent resistor 10, preferably a printed or thin film thermistor, of resistance R_{T} when unstrained, is connected in series with a temperature independent resistor 12 of unstrained resistance R. The thermistor 10 and the temperature independent resistor 12 are printed or deposited in close proximity on the same substrate, and optionally with an associated fixed load resistor 14 of resistance R_{L}.

The incorporation of a temperature independent resistor connected in series enables the determination or compensation of the mechanical strain while the optional series resistor makes it possible to calibrate the strain sensitivity of the device.

Under an applied strain ε at a particular temperature, the resistance of the temperature dependent resistor 10 will change by a fractional amount α_{T}ε to a value R_{T}(1+α_{T}ε). Similarly, the value of the temperature independent series resistor 12 will change by a fractional amount α_{S}ε to a value R_{S}(1+α_{S}ε). In the case of stretching, flexing or twisting of the substrate, or in all cases if the two resistors are of similar construction, α_{S} will have approximately the same value as α_{T}.

An electric potential V is connected to a terminal 16 and the potential difference across the different resistors can be measured at two additional terminals 18 and 20. If the load resistor 14 is not implemented the potential V is applied at the terminal 20 adjacent to the thermistor 10.

The ratio of the potentials V₂₀ (measured at the terminal 20) and V₁₈ (measured at the terminal 18) is given by the ratio of the actual resistances which are dependent on both the temperature and strain,

$$\frac{{V}_{20}}{{V}_{18}} = \frac{{R}_{S} ( 1 + {α}_{S} ɛ ) + {R}_{T} ( 1 + {α}_{T} ɛ )}{{R}_{S} ( 1 + {α}_{S} ɛ )} .$$

From the above equation, it can be seen that if α_{S}=α_{T} the ratio of the potentials is independent of the strain, and

$${R}_{T} = ( \frac{{V}_{20}}{{V}_{18}} - 1 ) {R}_{S} .$$

If the fractional changes in resistances caused by the strain are not exactly equal, there will be a weak strain dependence on the measured thermistor resistance which is linear to first order,

$${R}_{T} = ( \frac{{V}_{20}}{{V}_{18}} - 1 ) {R}_{S} ( 1 + ( {α}_{S} - {α}_{T} ) ɛ + … ) .$$

Determination of the actual coefficients of the strain dependence, or alternatively a measurement of the magnitude of the strain, requires a measurement of the potential difference across the load resistor 14, given by the difference in the applied potential V₁₆ measured at terminal 16 and V₂₀. For example, the strain is given by

$$ɛ = \frac{1}{{α}_{S}} ( \frac{{V}_{16} - {V}_{20}}{{V}_{18}} \frac{{R}_{L}}{{R}_{S}} - 1 ) .$$

Embodiments of the invention may comprise a single temperature sensing element, or an array of temperature sensing elements disposed in a pattern on a substrate and each connected electrically in series with a temperature independent resistor of similar construction, so that the potential difference across each sensing element and each temperature independent resistor, can be recorded and/or displayed by an external instrument. Preferably the temperature sensing elements comprise resistive components such as negative temperature coefficient (NTC) thermistors.

Existing thermistors of this general type are composed of pastes comprised of a powder of a compound semiconductor material and a binder material, such as a glass frit. This paste is either screen printed onto a ceramic substrate or cast to form a green body, after which it is sintered at high temperature to form a massive layer or body of semiconductor material. Invariably, because of distortion during the thermal treatment, further trimming of the material to obtain the correct resistance is required before metallization, in the case of thick-film thermistors.

The fabrication processes used place limitations on the substrate materials that can be used, precluding the use of many lightweight, flexible materials such as paper and polymer film. Traditionally, thick-film inks used for the fabrication of thermistors are composed of heavy metal sulphides and or tellurides, such as lead sulphide, and are not compliant with modern legislation such as the European Restriction on Hazardous Substances (ROHS). Recently introduced alternative materials include compositions of mixtures of rare earth and transition metal oxides, such as manganese oxide. Thermistors based on silicon are usually cut from heavily doped silicon wafers, and have a positive temperature coefficient of resistance.

These fabrication methods are not compatible with the use of conventional thermistors arrayed in a large area pattern on a flexible substrate. Therefore a printed device of the type described in our co-pending provisional application entitled Thermal Imaging Sensors, filed on 30 Jan. 2012, is preferred. Similarly, other components of the sensor array, including but not limited to temperature independent resistors, conductive tracks and insulators may also be printed onto the substrate material. Any commonly known printing process, such as screen printing, gravure printing, flexography and inkjet printing, which are applied in the printed electronics or thick film electronics industries, may be used.

As an alternative to an NTC thermistor, a positive temperature coefficient (PTC) thermistor or a resistance temperature device (RTD) may be used as the sensing element. The PTC thermistor may be an inorganic semiconductor of conventional art or be manufactured from a semiconducting polymer as described by Panda et al in WO 2012/001465. Similarly the RTD may be manufactured according to any known method, such as by forming a wire or thin film of a metal to the appropriate dimensions. Alternatively the RTD may be formed from a highly resistive printed track.

The disadvantages of using an RTD instead of a thermistor are firstly that the resistance of the RTD and its temperature dependence are comparable to that of the conductive tracks which connect the sensing elements of the array, and secondly that the relative change in resistance with temperature is small compared to that of a thermistor.

For the temperature independent resistor 12 it has been found that a particulate graphitic carbon ink of similar composition and particle loading to the silicon ink meets the above requirements when used in conjunction with a printed silicon thermistor. By extension, these considerations will apply to the use of other combinations of particulate resistor and semiconductor inks for the resistor and thermistor respectively. In particular it may be advantageous to use a highly doped (degenerate) semiconductor for the resistor which comprises the same material as used in the thermistor 10 with a low doping level (intrinsic or semi-insulating). Suitable inorganic semiconductor materials include group IV elements and their alloys, III-V or II-VI compounds and metal chalcogenides (including oxides, suphides and tellurides). If a mechanically homogeneous semiconducting polymer is used for the thermistor, the resistive ink should comprise a material with a similar elastic modulus.

A simple method of ensuring that a temperature dependent resistor and a temperature independent resistor occupy the same area on a flexible substrate is to overlay the two devices in a multilayer structure, with either the temperature dependent resistor being fabricated on top of the temperature independent resistor, or vice versa. Such a solution is undesirable for many reasons, with the two most pertinent being: the overall device will be considerably thicker than necessary (as in the following examples), and hence will be more rigid; and the complexity of the processing of a multilayer structure and the multiple interfaces may lead to mechanical instability, possibly resulting in delamination of the different components.

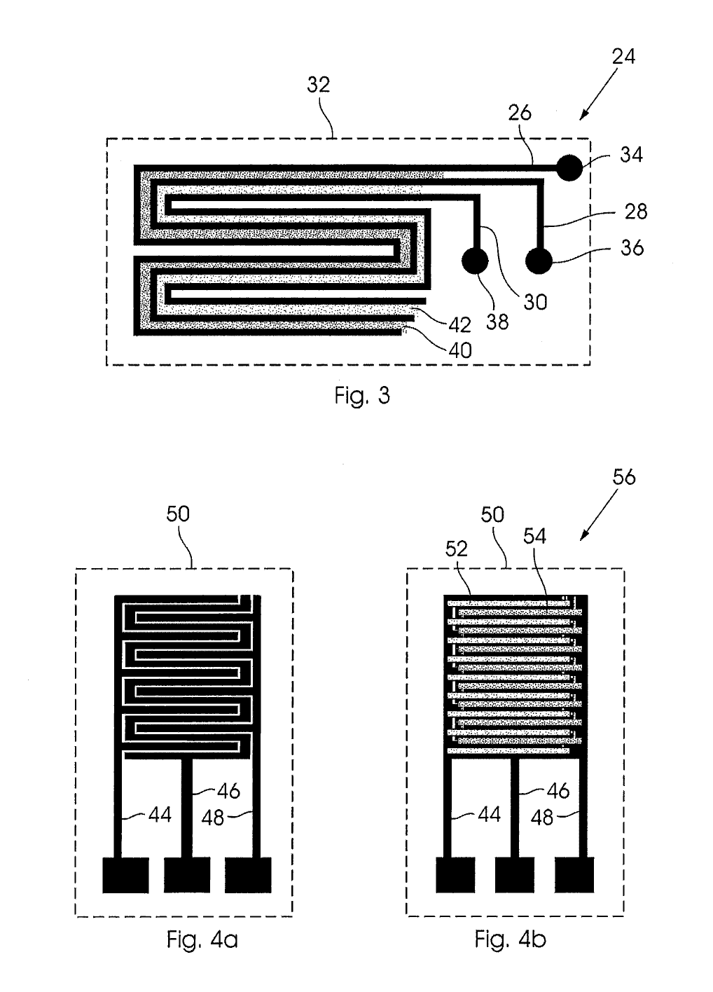

FIGS. 2 and 3 show first and second embodiments 22 and 24 of a strain compensated temperature sensor according to the present invention. The device 22 of FIG. 2 is a spiral patterned temperature and strain sensor incorporating two strain sensitive resistive tracks, one temperature dependent and one temperature insensitive. The device 24 of FIG. 3 is similar to that of FIG. 2 but is meander patterned.

In both embodiments, three parallel conducting tracks 26, 28 and 30 are deposited onto a thin flexible substrate 32 in a pattern with a constant separation between the tracks, but which otherwise fills the area over which the temperature is to be monitored. For the purposes of illustration, in the design shown in FIG. 2 the tracks are disposed in a square spiral pattern, but equally a rounded spiral, or a meander structure as shown in the embodiment of FIG. 3, or any combination of similar spiral and meander structures or other tortuous structures, may be used.

The material chosen for the substrate 32 should be appropriate to both the fabrication techniques used to manufacture the sensor device and the operating environment of the temperature sensor. For printed devices, of the type disclosed in PCT/IB2011/054001, suitable substrate materials include paper, fabric, polymer film and metal foil with an insulating coating.

The conductive tracks 26, 28 and 30 are extended to form a ground terminal 34 and terminals 36 and 38 corresponding to the terminals 18 and 20 in the representative circuit shown in FIG. 1. The physical device corresponding to the thermistor 10 of FIG. 1 is formed by depositing a suitable material, by an appropriate method such as printing or chemical or physical vapour deposition, between a first and second track of the conductive tracks. In a preferred embodiment the thermistor comprises a silicon nanoparticle ink deposited by screen printing. Similarly, the physical device corresponding to the temperature independent resistor 12 of FIG. 1 is deposited between the third track and the one adjacent to it. Preferably the resistor comprises a printed track of carbon, or a chalcogenide semiconductor, or a heavily doped semiconductor.

In the sensor device 22 of FIG. 2 a thermistor 40 is formed by the material spanning the tracks 26 and 28, while a temperature independent resistor 42 spans the tracks 28 and 30. In the sensor device 24 of FIG. 3, the equivalent components are numbered as for FIG. 2.

It is to be noted here that, because there is always a measurement resistor connected in series, this embodiment can be used to form the individual sensing elements of a larger thermal imaging array as disclosed in our South African provisional application 2012/00708 entitled Thermal Imaging Sensor, filed on 30 Jan. 2012.

After deposition of all the active elements, the sensor device may be encapsulated by any commonly known method, such as overprinting or coating with a sealant, such as a lacquer or varnish or polymer film, or by lamination with a plastic film as disclosed in PCT/IB2011/053999.

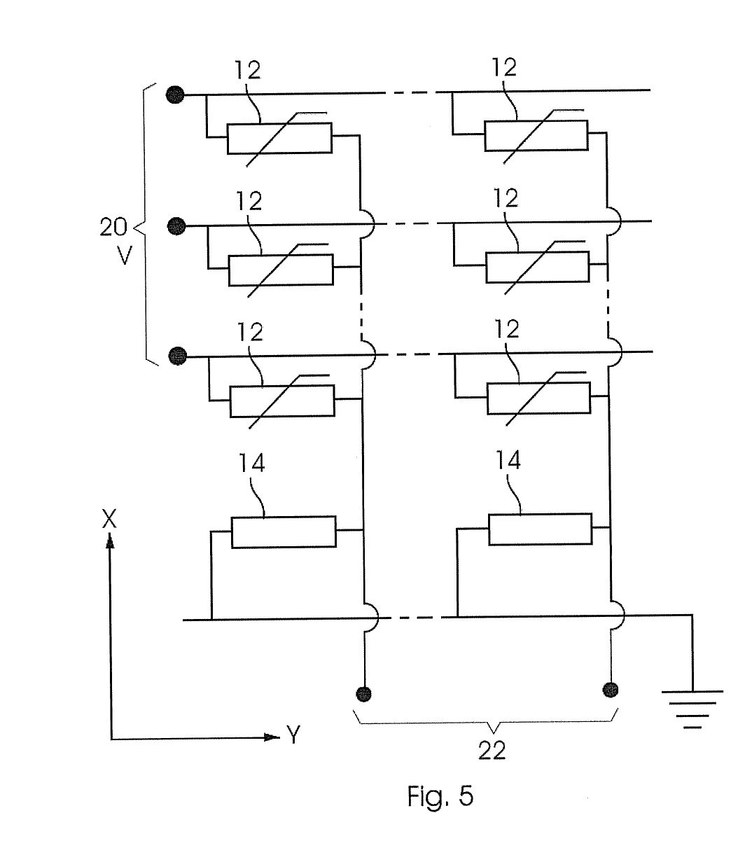

A third embodiment of the invention, which is well suited to measuring uni-axial strain or bending, is shown in FIG. 4. This embodiment can serve as a strain compensated flexible temperature sensor or as a combined strain and temperature sensor. This embodiment combines a pair of interdigitated tracks with a meandering third track and incorporates two sets of strain sensitive resistive tracks, one temperature dependent and one temperature insensitive, and has a preferred axis with enhanced strain sensitivity.

Referring first to FIG. 4a, two outer tracks 44 and 48 are disposed on a flexible substrate 50 in an interdigitated arrangement similar to that disclosed in PCT/IB2011/054001 as a suitable geometry for the tracks of a printed temperature sensor. A third track 46 follows a meandering path between the inwardly extending fingers of the two outer tracks.

As in the previous embodiments, the choice of materials used depends on both the fabrication process and the eventual operating environment, but thin flexible substrates such as paper, fabric, polymer film and insulated metal foil are preferred, and preferably the tracks 44, 46 and 48 should be printed with a conducting ink.

FIG. 4b shows a completed device 56. A thermistor (equivalent to the thermistor 10 of FIG. 1) is created by depositing a plurality of elongate strips 52 of thermistor material between adjacent fingers of the tracks 44 and 46. Similarly, a temperature independent resistor (corresponding to the temperature independent resistor 12 of FIG. 1) is created by depositing a plurality of elongate strips 54 of suitable resistive material between adjacent fingers of the tracks 46 and 48, using the same materials and in the same manner as for the first and second embodiments.

It is not necessary for the complete path between each pair of tracks or electrodes to be bridged by either the thermistor or the resistor material. Instead, as shown in FIG. 4b, it is preferable that only the long edges of the parallel fingers or contacts are connected. In this way, the thermistor and the resistor are aligned along parallel axes. With this geometry, strain or curvature in the direction along the length of the printed tracks is unlikely to cause a significant change in the geometry of either component. However a strain or bending in a direction perpendicular to the length of the printed tracks will have an enhanced effect on the resistances of the thermistor and resistor, due to a change in the separation of the electrodes. Hence this preferred embodiment is particularly sensitive to a uni-axial strain or bending and can be applied either as a strain compensated flexible temperature sensor or as a combined strain and temperature sensor as described above.

1. A sensing device including a first, temperature dependent resistor, a second, substantially temperature independent resistor connected in series with the temperature dependent resistor, and at least one electrical contact by means of which an electrical potential difference can be applied across both resistors simultaneously, wherein both the temperature dependent resistor and the substantially temperature independent resistor are sensitive to mechanical strain.

2. The sensing device of claim 1 wherein the temperature dependent resistor and the substantially temperature independent resistor are of substantially similar construction and hence have a similar response to a mechanical force applied to them.

3. The sensing device of claim 2 wherein the temperature dependent resistor and the substantially temperature independent resistor are supported by or mounted on a common substrate, which is flexible or elastic.

4. The sensing device of claim 3 wherein both the temperature dependent resistor and the substantially temperature independent resistor are located adjacent one another in or on the substrate.

5. The sensing device of claim 1 including a third, load resistor, the resistance of which is substantially unaffected by either the mechanical strain or the change in temperature experienced by the first and second resistors.

6. The sensing device of claim 5 wherein the load resistor is a rigid temperature independent resistor in or on the substrate.

7. The sensing device of claim 5 wherein the load resistor is a fixed resistor located at a point in an associated monitoring circuit which is not subject to the mechanical strain or the change in temperature experienced by the first and second resistors.

8. A strain compensated temperature sensor including a sensing device according to claim 1, the sensing device including first and second strain sensitive resistive sensor elements, one temperature dependent and one temperature insensitive.

9. The strain compensated temperature sensor of claim 8 wherein the first and second strain sensitive resistive sensor elements comprise first, second and third conductive tracks, with a first track of resistive material extending between the first and second conductive tracks, and a second track of resistive material extending between the second and third conductive tracks.

10. The strain compensated temperature sensor of claim 9 wherein the first and second strain sensitive sensor elements have a spiral or meander pattern.

11. The strain compensated temperature sensor of claim 8 wherein the first and second strain sensitive resistive sensor elements comprise interdigitated first and second conductive tracks, with a meandering third conductive track disposed between the interdigitated first and second conductive tracks, with at least one first track of resistive material extending between the first conductive track and the third conductive track, and at least one second track of resistive material extending between the second conductive track and the third conductive track.

12. The strain compensated temperature sensor of claim 11 including a plurality of first and second tracks of resistive material arranged alternately so that each first track of resistive material extends between a finger of the first conductive track and the third conductive track, and each second track of resistive material extends between a finger of the second conductive track and the third conductive track.
